(19) United States
(12) Patent Application Publication
(10) Pub. No.: US 2006/0075605 A1
(43) Pub. Date: Apr. 13, 2006

(54) Adjustable grasping assembly for tools

(76) Inventors: Mike Lagaly, Jackson, TN (US); James Patton, Humboldt, TN (US)

Correspondence Address: SUITER WEST SWANTZ PC LLO, 14301 FNB PARKWAY, SUITE 220, OMAHA, NE, 68154, US

(21) Appl. No.: 10/282,590

(22) Filed: Oct. 29, 2002

Related U.S. Application Data
(60) Provisional application No. 60/400,559, filed on Aug. 2, 2002.

(51) Int. Cl. B25G 1/10

(52) U.S. Cl. 16/430

(57) ABSTRACT

The present invention is directed to an assembly for providing ergonomic grasping for a category of tool users. The assembly may be sized for ergonomic grasping by the hand of a user belonging to a category, such as large, medium, or small. The assembly includes a generally flat surface and a surface generally shaped for reception in a user's palm. The assembly of the present invention may be employed with a power tool or pneumatic tool, such as a hand held tool. A securing extension for securing the base to a tool is mounted on the generally flat surface.

### CROSS REFERENCE

The present application claims priority to U.S. Provisional Patent Serial No. 60/400,559, entitled: Adjustable Grasping Assembly for Tools, filed on Aug. 2, 2002 which is hereby incorporated in its entirety.

### FIELD OF THE INVENTION

The present invention relates to the field of hand tools and particularly to an apparatus for providing a comfortable grip for a tool user.

### BACKGROUND OF THE INVENTION

Hand tools such as power tools, pneumatic tools and the like may be utilized by a variety of users. Because of this, the size of various user's hands may vary. Thus, some users experience discomfort while operating the tool. For instance, a person with a small hand or a large hand, in comparison to the bulk of users, may strain their hand, wrist, and arm muscles to grasp a tool such as a drill, a circular saw, a reciprocating saw, and the like.

In addition to the discomfort of grasping the tool, operation of the tool may cause vibration which may lead to additional user discomfort. For example, operating a hammer drill may cause vibration leading to user fatigue and discomfort. In another example a reciprocating saw may vibrate when a hard object, such as a nail, is encountered while operating.

Customizing a gripping system to a particular user's hand may be expensive, time consuming, and burdensome.

Therefore, it would be desirable to provide an adjustable grasping assembly for hand tools which provides a category of users with a comfortable hand grip.

### SUMMARY OF THE INVENTION

Accordingly, the present invention is directed to an apparatus for providing semi-customized gripping system for utilization with power and pneumatic tools such as hand-held tools. The apparatus and method of the present invention permits ease of adjustment and semi-customization of a tool so as to promote ergonomic gripping for various categories of users.

In an aspect of the invention, an assembly for promoting ergonomic grasping includes a base with a generally flat surface and a surface generally shaped for reception in a user's palm. The assembly of the present invention may be employed with a power tool or pneumatic tool, such as a hand-held tool. A securing extension for securing the base to a tool is mounted on the generally flat surface. The assembly may be sized for ergonomic grasping by the hand of a user belonging to a category, such as large, medium, or small.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a perspective view of an assembly for providing ergonomic grasping implemented with a cordless drill;

FIG. 2 is an exploded view of an assembly for providing ergonomic grasping implemented with a cordless drill;

FIG. 3 is an enlarged perspective view of an assembly for providing ergonomic grasping, including tabs for minimizing deformation;

FIG. 4 is an end view of an assembly for providing ergonomic grasping, including surface texturing;

FIG. 5 is a side perspective view of an assembly for providing ergonomic grasping including surface texturing;

FIG. 6 is a cross sectional view of FIG. 5 made along section line 6-6; and

FIG. 7 is a perspective view of an assembly for providing ergonomic grasping implemented with a cordless circular saw.

### DESCRIPTION OF THE INVENTION

Reference will now be made in detail to the presently preferred embodiments of the invention, examples of which are illustrated in the accompanying drawings.

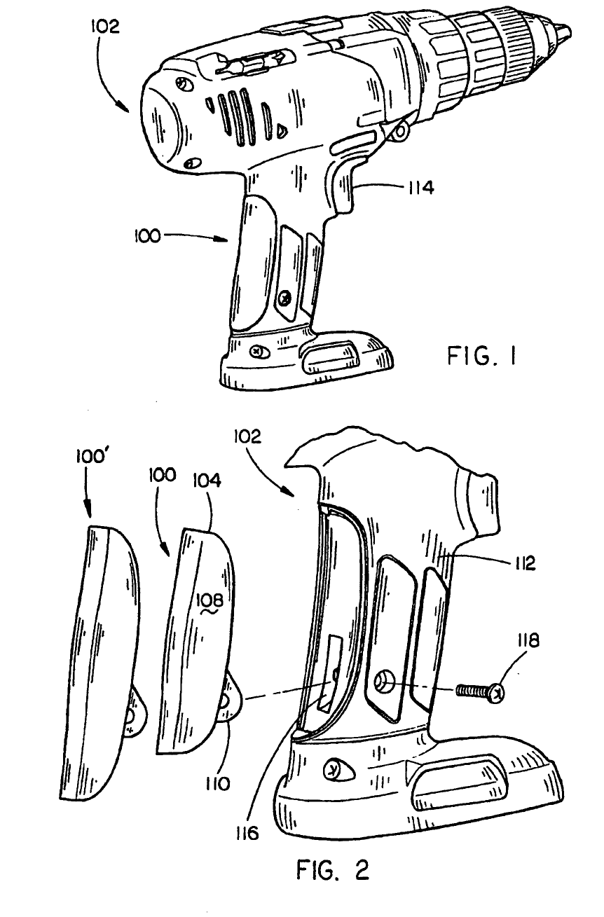

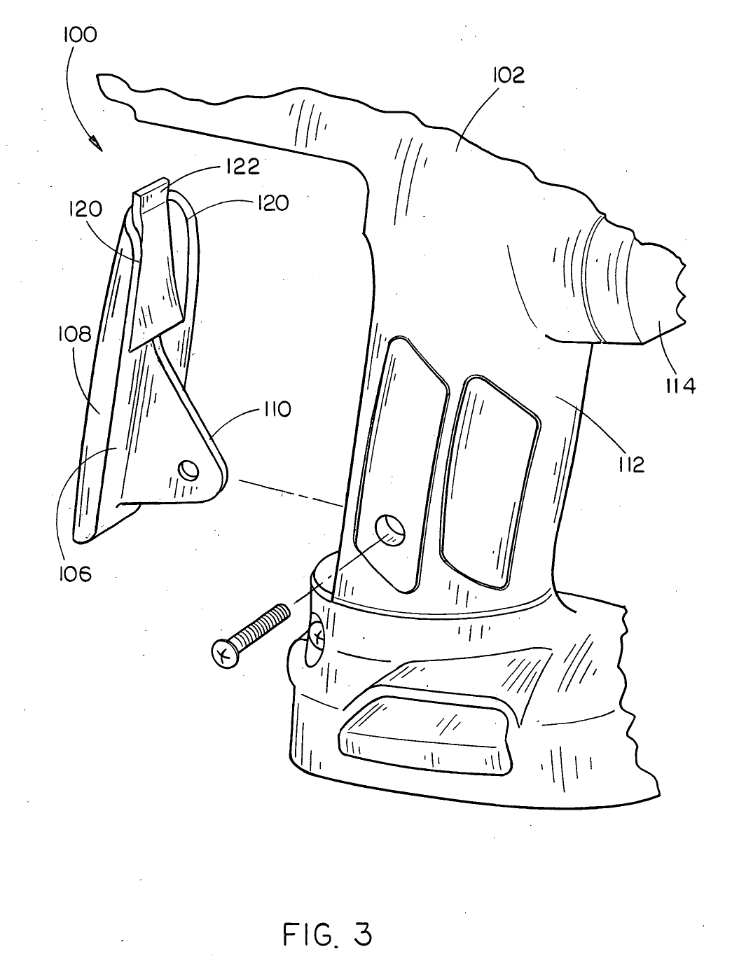

Referring generally now to FIGS. 1 through 7, exemplary embodiments of the present invention are shown. The apparatus of the present invention overcomes the difficulties previously experienced and promotes ergonomic grasping for various categories of users.

Referring to FIGS. 1 through 7, an adjustable grasping assembly 100 is discussed. The assembly 100 of the present invention promotes ergonomic gripping for categories of users. For instance, a user's palm may correspond to a particular category such as large, medium or small. The assembly 100 promotes ergonomic gripping by allowing a user to semi-customize the fit of the tool. For example, several different sizes of assemblies may be included with a tool, or assemblies with various characteristics, such as differing levels of elasticity, gripping surfaces, styles, colors and the like. Thus, tool manufacturers may increase overall user satisfaction, without the expense associated with customization.

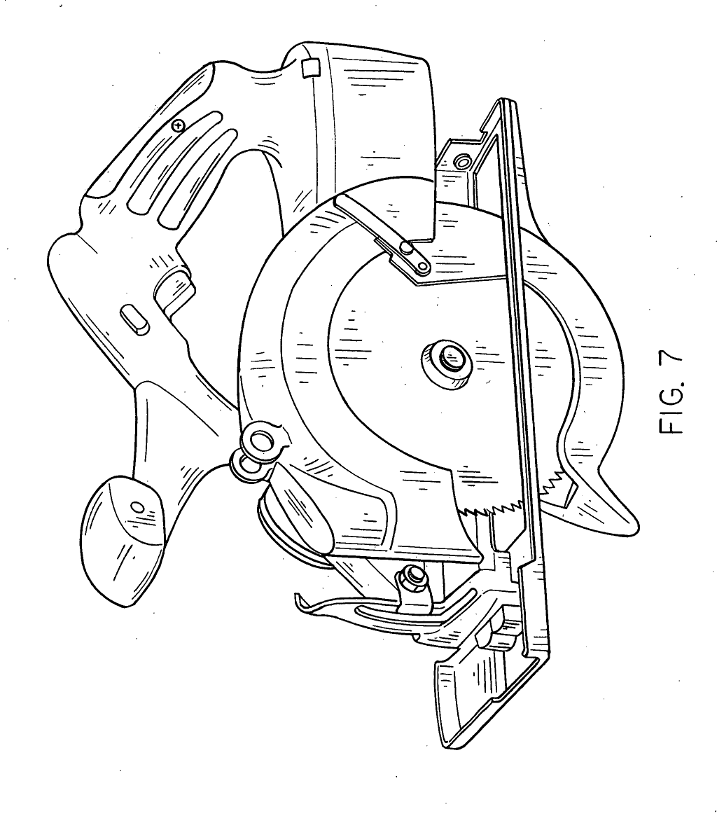

The assembly 100 includes a base 104 with a generally flat surface 106 for being received by a handle included in a tool, such as a power tool or a pneumatic tool. See also generally FIGS. 5 and 6. The assembly 100 may be mounted to a stock type handle 112 generally opposite a switch for controlling power or the flow of air to the tool. For example, the switch is a trigger switch 114 for operating a cordless drill 102. In further examples, the assembly 100 may be implemented with a circular saw (see generally FIG. 7), a drill, a reciprocating saw, a jig saw, a belt sander, a D-handled router, a hammer drill, and the like.

A securing extension 110 is mounted to the generally flat surface 106 of the base. The extension 110 is suited to secure the base to the tool. For instance, the extension 110 is generally triangularly shaped to be received in a corresponding recess 116 included in a tool handle 112. The securing extension 110 may be mechanically secured to the handle via a screw, pin, a friction lock and the like. For example, a screw 118 may be threaded through an aperture in the extension to interconnect to a threaded nut or sleeve secured into a plastic tool handle. Those of ordinary skill in the art will appreciate that various methods are available for securing a threaded sleeve or nut into a handle, such as gluing, sonic welding, hot pressing and the like; it is the intention of this disclosure to encompass and include such variations.

The base 104 also contains a surface at least partially shaped for reception in a user's palm 108. For example, a user may grasp the base 104 in between their thumb and fingers so the assembly 100 forms a grasping cushion. In a further aspect, the portion of the base shaped for grasping may include a concave portion, such as on the end generally opposite a user's thumb, for allowing the user a better grip. Moreover, the present invention may permit a user's fingers and thumb to grasp a handle itself, thus insuring a secure grip. In another example, the assembly may be implemented with a tool employing frictional gripping zones as disclosed in U.S. Pat. No. 6,308,378 entitled: Frictional Gripping Arrangement for a Power Tool Handle, which is hereby incorporated in its entirety. For instance, the assembly 100 may act as cushion, so as to promote ergonomic grasping, thus reducing muscle strain and user fatigue.

In further embodiments, the portion of the base 104 shaped for reception in a user's palm 108 may be over-molded, co-molded or coated with material for aiding in grasping, such as an elastomeric or plyable type material. Additionally, elastomeric material may dampen vibration, such as when the assembly is utilized with a hammer drill and the like. For instance, the base may be overmolded with a thermoplastic elastomer. When the base is over-molded, the base may be formed of a rigid plastic material, such as a nylon or the like. Moreover, the assembly may be constructed of various polymers or combination of polymers, such as elastomeric materials, gel material encapsulated in a polymeric/plastic type material and the like.

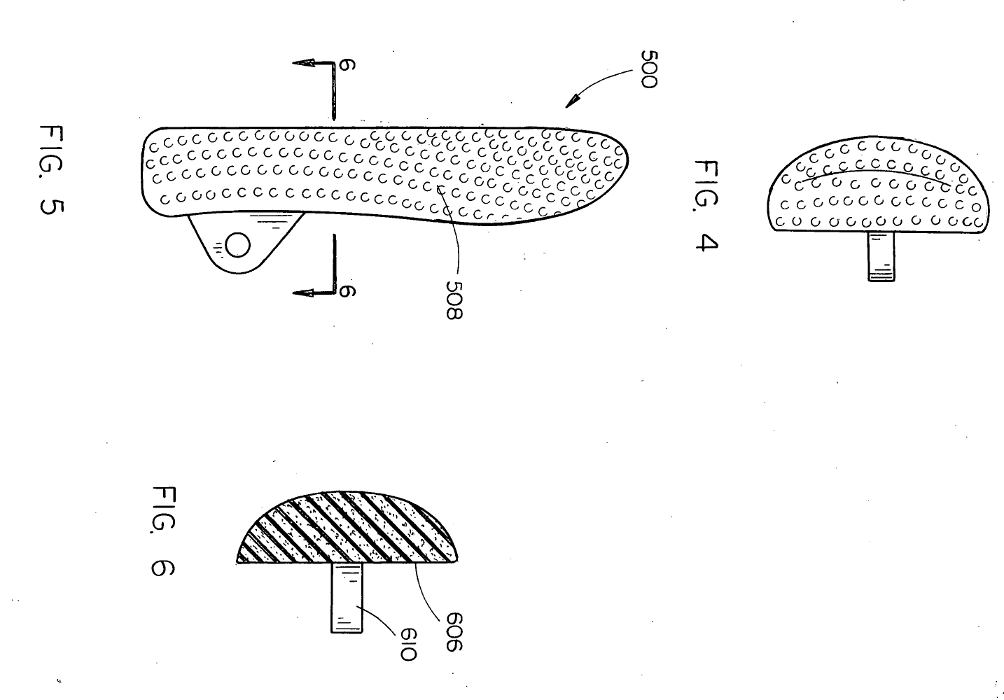

Referring to FIGS. 4 and 5, the surface of the base for grasping 508, over-molding or coating may include texturing to aid in grasping, wick away sweat and the like. For instance, the grasping surface 508 may include a series of raised protrusions or bumps for engaging a user's palm.

In an additional aspect, the base 104 may include a tab for engaging the tool handle. For instance, two side tabs 120 and an end tab 122 are shown. Tabs may aid in maintaining the apparatus in a desired orientation and/or prevent deformation of the apparatus during use, such as when a user twists the assembly 100.

It is believed that the apparatus of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. An adjustable grasping assembly, comprising:
a base including a surface at least partially shaped for being received in a category of user's palm; and
a securing extension mounted to the base, for securing the base to a tool;
wherein the assembly is sized to promote ergonomic grasping for a category of users, the category of users having a hand size that is one of a small, medium or large size.

2. The adjustable grasping assembly of claim 1, wherein the base is formed of a rigid plastic.

3. The adjustable grasping assembly of claim 1, further comprising an elastomeric over molding disposed on the surface of the base at least partially formed for reception in a user's palm.

4.-7. (canceled)

8. The adjustable grasping assembly of claim 1, further comprising at least one tab connected to the base for minimizing deformation during use.

9.-30. (canceled)

31. A comfort grip tool, comprising:
a handle for manipulating the tool;
a switch mounted in the handle, for controlling a motor included in the tool;
a base connected to the handle generally opposite the switch, having a generally flat surface, orientated towards the handle, and a surface at least partially shaped for being received in a category of user's palm; and
a securing extension mounted to the generally flat surface of the base, for securing the base to the handle;
wherein the base is sized to promote ergonomic grasping for a category of users, the category of users having a hand size that is one of a small, medium or large size.

32. The comfort grip tool of claim 31, wherein the switch is a trigger switch.

33. The comfort grip tool of claim 31, wherein the base is formed of a rigid plastic.

34. The comfort grip tool of claim 31, further comprising an elastomeric over-molding disposed on the surface of the base at least partially formed for reception in a user's palm.

35.-38. (canceled)

39. The comfort grip tool of claim 31, further comprising an outer coating co-molded with the base.

40.-41. (canceled)

42. The comfort grip tool of claim 31, further comprising at least one tab connected to the base for minimizing deformation during use.

43. The comfort grip tool of claim 31, wherein the securing extension is unitary with the base.

44. The comfort grip tool of claim 31, wherein the tool is at least one of a circular saw, a drill, a reciprocating saw, a jig saw, a power planner, a belt sander, a D-handled router, a power screw driver, and a hammer drill.

45. The comfort grip tool of claim 31, wherein the handle is at least one of a stock type and a D-handle type.

46. A comfort grip power tool, comprising:
a handle for manipulating the power tool;
a trigger switch mounted to the handle, for controlling the power tool's motor;
a base connected to the handle, substantially opposite the side of the handle including the switch, having a generally flat surface, orientated towards the handle, and a surface at least partially shaped for being received in a category of user's palm;
a tab connected to the base, for engaging the handle to minimize deformation; and
a securing extension mounted to the generally flat surface of the base, for securing the base to the handle;
wherein the base is sized to promote ergonomic grasping for a category of users, the category of users having a hand size that is one of a small, medium or large size.

47. The comfort grip tool of claim 46, wherein the base is formed of a rigid plastic.

48. The comfort grip tool of claim 46, further comprising an elastomeric over-molding disposed on the surface of the base at least partially formed for reception in a user's palm.

49.-52. (canceled)

53. The comfort grip tool of claim 46, further comprising an outer coating co-molded with the base.

54.-55. (canceled)

56. The comfort grip tool of claim 46, further comprising at least one tab connected to the base for minimizing deformation during use.

57. The comfort grip tool of claim 46, wherein the securing extension is unitary with the base.

58. The comfort grip tool of claim 46, wherein the tool is at least one of a circular saw, a drill, a reciprocating saw, a jig saw, a power planner, a belt sander, a D-handled router, a power screw driver, and a hammer drill.

59. The comfort grip tool of claim 46, wherein the handle is at least one of a stock type and a D-handle type.

60. A power tool kit, comprising:
a power tool having a handle for manipulating the power tool;
a first removable grasping assembly being at least partially shaped for reception in a first category of user's palm, the first category of users having a hand size that is one of a small, medium or large size; and
a second removable grasping assembly being at least partially shaped for reception in a second category of user's palm, the second category of users having a hand size that is one of a small, medium or large size,
wherein the first removable grasping assembly is of a different size than the second removable grasping assembly.

61. The power tool kit of claim 60, wherein the first and the second grasping assemblies are formed of rigid plastic.

62. The power tool kit of claim 60, wherein the first and the second grasping assemblies are formed with an elastomeric over molding.

63. The power tool kit of claim 60, wherein the first and the second grasping assemblies are textured for aiding in grasping.

64. The power tool kit of claim 60, wherein the first and the second grasping assemblies individually include a securing extension configured to be received in the handle, the power tool kit being additionally configured to extend a fastener transverse to the securing extension included on at least one of the grasping assemblies.
